(19) United States
(12) Patent Application Publication
(10) Pub. No.: US 2004/0180195 A1
(43) Pub. Date: Sep. 16, 2004

(54) Housewrap

(76) Inventor: James A. Macuga, Concord, OH (US)

Correspondence Address: Cynthia S. Murphy, Renner, Otto, Boisselle & Sklar, LLP, 1621 Euclid Avenue, Nineteenth Floor, Cleveland, OH, 44115-2191, US

(21) Appl. No.: 10/793,620

(22) Filed: Mar. 4, 2004

Related U.S. Application Data
(60) Provisional application No. 60/454,983, filed on Mar. 14, 2003.

(51) Int. Cl. E06B 3/24

(52) U.S. Cl. 428/343

(57) ABSTRACT

Housewrap (10) for attachment to a building (12) after installation of sheathing (14) and prior to installation of siding/cladding. The housewrap comprises a barrier layer (20) and an adhesive layer (22). The barrier layer (20) has a first surface (24), which faces inward relative to the building (12), and a second surface (26), which faces outward relative to the building (12). The adhesive layer (22) is applied to the first surface (24) for attachment of the housewrap (10) to the sheathing (14). The barrier layer (20) provides a moisture barrier against outside water or moisture, yet allows a water vapor transmission rate of at least 100 g/m²/day from the interior of the building (12). The adhesive layer (22) comprises a pressure sensitive adhesive that has a high moisture vapor transmission rate of at least about 100 g/m²/day.

### RELATED APPLICATIONS

This application claims priority under 35 U.S.C. §119(e) to U.S. Provisional Patent Application No. 60/454,983 filed on Mar. 14, 2003. The entire disclosure of this earlier application is hereby incorporated by reference.

### FIELD OF THE INVENTION

This invention relates generally, as indicated, to a housewrap and, more particularly, to a material used for wrapping the exterior surfaces of buildings prior to the attachment of siding materials.

### BACKGROUND OF THE INVENTION

Housewrap is used to wrap the exterior surface of a house or other building during its construction and, more particularly, after attachment of sheathing and prior to installation of siding/cladding. Housewrap is typically provided in roll form, whereby sheets of suitable lengths may be conveniently dispensed (e.g., unrolled) and then separated (e.g., cut, torn, etc.) from the remainder of the roll. The housewrap usually has a standard width of more than 2 feet (e.g., 3 feet, 6 feet or 9 feet), and the roll supplies a predetermined length (e.g., 150 feet) of the housewrap.

Housewrap commonly comprises a barrier layer which provides a moisture barrier against outside water or moisture, yet allows water vapor transmission from the interior of the housing. In this manner, the passage of liquid water and air (e.g., rain and wind) into the building structure is restricted, thereby preventing the water damage of insulation and structural members and minimizing air movement within the walls. At the same time, water vapor which enters the walls from the interior of the building structure can exit so that it does not condense within the wall and potentially damage insulation and structural members. Typical housewrap barrier materials include spunbonded high density polyethylene fibers sold under the trade designation “DuPont Tyvek Housewrap” by DuPont Company, Wilmington, Del.; non-woven barrier material sold under the trade designation “Commercial Wrap” by DuPont Company, Wilmington, Del.; spunbonded polypropylene fibers sold under the trade designation “Typar Housewrap” by Reemay Inc., Old Hickory, Tenn.; high density, cross-laminated microperforated polyethylene sheet material sold under the trade designation “Rufco-wrap” by Raven Industries, Inc., Sioux Falls, S. Dak.; and the cross-woven microperforated polyolefin sheet materials sold by Amoco Foam Products Company, Atlanta, Ga., and Fabrene Inc., Mississauga, Ontario, under the trade designations “Amowrap Housewrap” and “Air-Gard Housewrap,” respectively.

Typically, a plurality of housewrap sheets are required to cover a house or other building. For example, long strip-like sheets can be dispensed from a roll and then hung vertically (like wallpaper) along, or run horizontally across, the building. In either or any event, the housewrap sheets can be attached to the sheathing using staples, large head nails, or plastic washer nails. Horizontal and vertical joints (or seams) will exist between adjacent housewrap sheets, and these can be taped or otherwise sealed to render the joint(s) air and water tight.

A survey conducted by the Pennsylvania Housing Research Center has revealed that, in many instances, housewrap is not being properly installed. In fact, ninety-three percent of the installations surveyed did not tape or otherwise seal joint locations. Seventy percent of the installations surveyed used staples, and many of these installations had tears or holes because of overly robust installation techniques. The presence of holes and sloppy installation techniques raised concerns as to the actual effectiveness of the installed housewrap. Also, under suction pressures, stapled housewrap was found to balloon away from the sheathing and, in some instances, the housewrap tore at fastener locations at pressure levels below the service wind loads suggested by the relevant code. (See PHRC Report #59—Executive Study.) Moreover, attachment of housewrap via staples or nails can be difficult, complicated, and possibly even dangerous when wind gusts are present during installation.

It has been proposed to use a pressure sensitive adhesive for attachment purposes in a housewrap-type product. When a pressure sensitive adhesive is used, it eliminates the problems associated with staples and nails and can also ease installation procedures. However, unlike staples and nails, an adhesive layer presents the potential to block the transmission of moisture vapor through the barrier layer. Vapor transmission issues were addressed in the past by using an edge-only adhesive, by a careful positioning of the adhesive relative to the barrier layer, by forming perforations in the adhesive layer and aligning them with perforations in the barrier layer, and/or by strategically locating different types/densities of adhesives on respective regions of the barrier layer. Needless to say, these suggested solutions can complicate manufacturing procedures. Moreover, most of these solutions have only been proposed in the context of sealing strips or tapes (e.g., about two to four inches wide), not in housewrap designed to cover large areas of houses.

### SUMMARY OF THE INVENTION

The present invention provides a housewrap having an integral adhesive attachment means (e.g., an adhesive layer), whereby nails and staples are not necessary, thereby eliminating the disadvantages associated therewith. The adhesive attachment means can also serve joint-sealing purposes without the need for tape or other sealing means. A notable characteristic of the present invention is that it addresses, and solves, vapor transmission issues without complicating manufacturing procedures and in a manner compatible with housewrap designed to cover large areas of houses.

More particularly, the present invention provides housewrap for attachment to a building after installation of sheathing and prior to installation of siding/cladding. The housewrap comprises a barrier layer having a first surface, which faces inward relative to the building, and a second surface, which faces outward relative to the building. An adhesive layer is applied to the first surface of the barrier layer for attachment of the barrier layer.

The barrier layer provides a moisture barrier against outside water or moisture, yet allows a water vapor transmission rate of at least 100 g/m²/day from the interior of the building. The barrier layer can be a polyolefin material and/or a spun-bonded material, and, in any event, is preferably non-perforated (i.e., no microperforations or minute passageways). Suitable materials for the barrier layer include TYVEK, a high density polyethylene spun-bonded sheet material from Dupont Company, Wilmington, Del., and/or TYPAR house wrap, a spun-bonded polypropylene fiber mat material from Reemay, Inc., Old Hickory, Tenn.

The layer of adhesive comprises a pressure sensitive adhesive that has a high moisture vapor transmission rate. More specifically, the pressure sensitive adhesive has a moisture vapor transmission rate of at least about 100 g/m²/day, at least about 200 g/m²/day, at least about 300 g/m²/day, and/or at least about 400 g/m²/day. The pressure sensitive adhesive is preferably a non-rubber-based adhesive and/or is preferably an acrylate-based adhesive.

By using a high MVTR adhesive, water vapor can pass through the adhesive layer without necessarily requiring an edge-only adhesive layer, without careful positioning of the adhesive layer relative to the barrier layer, with no alignment of perforations in the adhesive layer with perforations in the barrier layer, and/or without the use of different types of adhesives. For example, the high MVTR pressure sensitive adhesive can extend to the perimeter barrier layer, the barrier layer can be non-perforated, the adhesive layer can completely cover the first surface of the barrier layer, and/or the adhesive layer can be applied in a pattern unrelated to perforations in the barrier layer.

If the adhesive layer is applied in a pattern, it can be a continuous pattern or a discontinuous pattern and can comprise, for example, a patchwork design having unconnected squares, a smooth rounded sine wave, a sharp triangular sine wave (e.g. zig-zag), a honeycomb, a series of dots, a series of stripes, a random-void, and/or a perimeter border. If the adhesive layer is patterned, the pattern can be such that a sufficient amount of adhesive will be positioned on the perimeter edges of the barrier layer for joint-sealing purposes. (This feature is inherent with a substantially complete coverage adhesive layer.) Specifically, when installing housewrap sections, adjacent edges of neighboring sections should be able to simply overlap to seal the joint therebetween. More specifically, the adhesive layer of a first section will be attached to the sheathing, and the adhesive layer of a second section will be attached to barrier layer of the first section. In this manner, joint-sealing can be accomplished without the need for tape or other sealing means.

The housewrap can have a width of at least about 1 foot and/or 2 feet, since it is intended to cover large areas on the building. (That being said, certain aspects of the present invention can be incorporated into much narrower sealing tapes/strips.) The housewrap can be provided in a roll and have an unrolled length of at least ten times its width. Alternatively, the housewrap can be provided in sheets having a length within 20% of its width, about the same as its width, or longer than its width. In either or any other case, the housewrap can further comprise a release liner positioned adjacent to the adhesive layer or a release coating applied to the second surface of the barrier layer. With particular reference to the release coating, this may be especially convenient when the housewrap is provided in roll form, whereby the adhesive layer of an outer coil contacts the barrier layer of the adjacent coil.

Black mold (Stachybotris) and other mold problems have been known to invade homes and other buildings. The invasion usually occurs at locations susceptible to moisture, as a wet environment can supply constant source of food for the mold. In any event, air quality experts and doctors have linked mold to illnesses ranging from dry coughs and runny noses to oozing rashes and constant fatigue. Since housewrap is designed to accommodate moisture transmission from the interior of the house, it can certainly be considered a mold-susceptible location. The present invention provides for the addition of a fungicide to the adhesive layer to combat the creation of mold between the sheathing and the barrier layer. The fungicide can be a pyrithione and, more particularly, a zinc pyrithione.

These and other features of the invention are fully described and particularly pointed out in the claims. The following description and drawings set forth in detail certain illustrative embodiments of the invention, which are indicative of but a few of the various ways in which the principles of the invention may be employed.

### DRAWINGS

FIG. 1A is a fragmentary view of a building with housewrap according to the present invention attached thereto, the housewrap being provided in long sections that are hung vertically.

FIG. 1B is a fragmentary view of a building with housewrap according to the present invention attached thereto, the housewrap being provided in long sections and run horizontally.

FIG. 2 is a fragmentary view of a building with housewrap of the present invention attached thereto, the housewrap being provided in rectangular sections and applied in rows and columns.

FIG. 3 is a perspective view of a roll of the housewrap, which can be used to supply the long housewrap sections shown in FIGS. 1A and 1B.

FIG. 4 is a perspective view of a pile of rectangular sections of the housewrap shown in FIG. 3.

FIG. 5 is a side view of the housewrap according to the present invention, the housewrap comprising a barrier layer and a layer of adhesive.

FIG. 6 is a side view similar to FIG. 5, with a release liner temporarily positioned below the adhesive layer.

FIG. 7 is a side view similar to FIG. 5, with a release coating applied above the barrier layer.

FIGS. 8A-8K are bottom views of the housewrap material of FIG. 5, showing different coverage/pattern options for the adhesive layer.

FIG. 9 is a close-up sectional view of a joint between adjacent housewrap edges in FIGS. 1A, 1B and 2.

### DETAILED DESCRIPTION

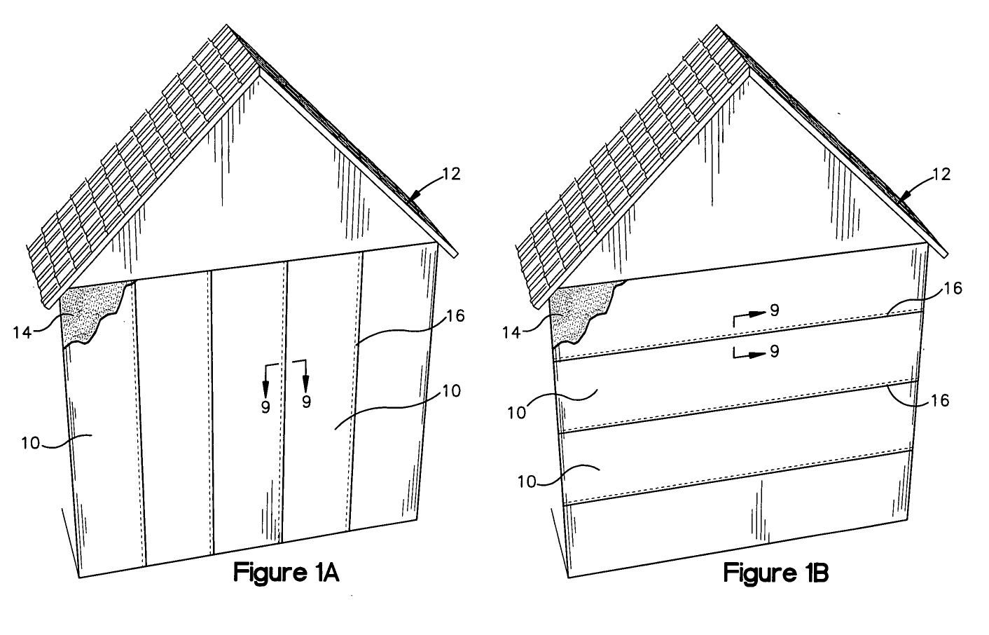

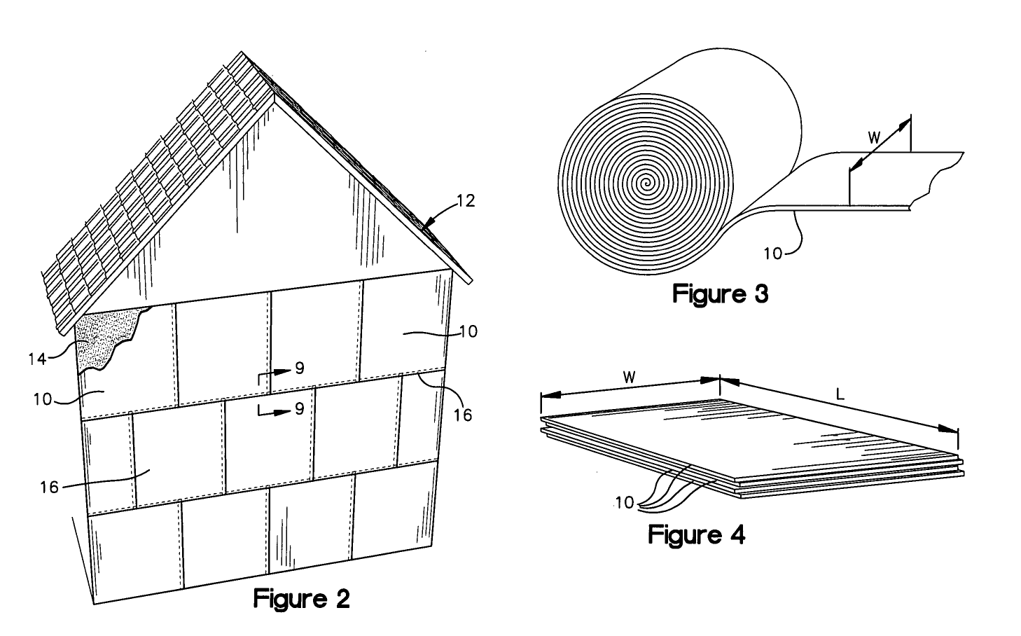

Referring now to the drawings, and initially to FIGS. 1A, 1B and 2, housewrap 10 according to the present invention is shown attached to a house or other building 12. The housewrap 10 is attached to the building 12 after installation of sheathing 14 and prior to installation of siding/cladding (not shown). In FIGS. 1A and 1B, the housewrap 10 is provided in long sections and is respectively hung vertically (FIG. 1A) and run horizontally (FIG. 1B). In FIG. 2, the housewrap 10 is provided in rectangular sections. In any event, a plurality of housewrap sections are typically necessary, whereby vertical and/or horizontal joints 16 exist between adjacent sections.

The long sections of housewrap 10 used in FIGS. 1A and 1B can be provided in a roll such as that shown in FIG. 3. The rolled housewrap 10 can have a width W of greater than two feet wide, about or greater than 3 feet wide, about or greater than 6 feet wide, and/or about or greater than 9 feet wide. The roll can be a suitable length for transportation and/or installation purposes, such as 150 feet long. The housewrap 10 provided in roll form usually has an unrolled length of at least about ten times its width, at least about twenty times its width, and/or at least about thirty times its width.

The rectangular sections of housewrap 10 used in FIG. 3 can be provided in a stack such as that shown in FIG. 4. The rectangular sections can have a width W of about one foot, greater than one foot, greater than two feet, about or greater than 3 feet, about or greater than 6 feet, and/or about or greater than 9 feet and a length L within 20% of the width, within 30% of the width, within 50% of the width, about the same as the width, or longer than the width. The rectangular shape of the sections often is the most compatible with housewrap applications, and the size is selected to accommodate transportation and/or installation purposes. That being said, other non-rectangular shapes (e.g., triangular, curved-sides) are possible with and contemplated by the present invention. In fact, one advantage of the sectional housewrap (as opposed to the roll) is that the shapes can be chosen to accommodate the architecture of a particular building.

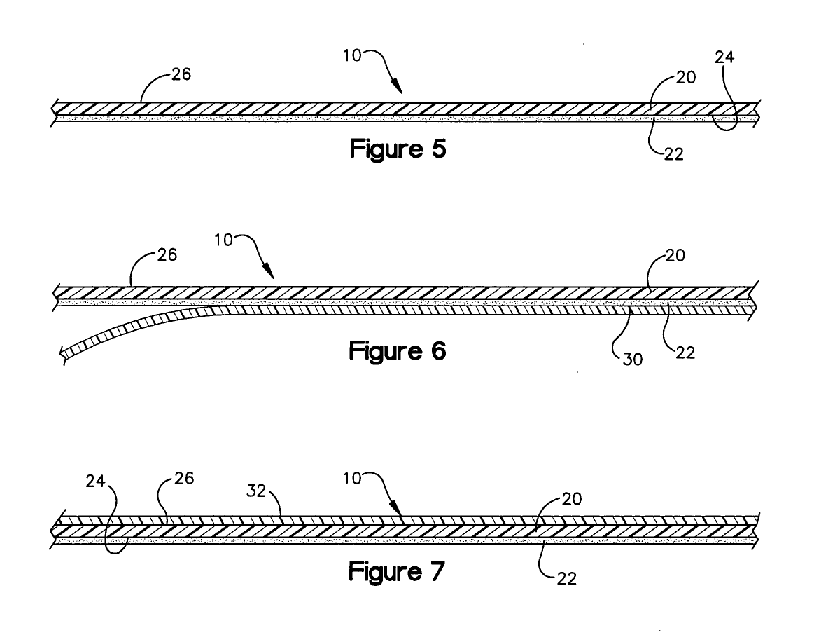

Referring now to FIG. 5, the housewrap sheet 10 according to the present invention is shown isolated from the building 12. The housewrap sheet 10 comprises a barrier layer 20 and an adhesive layer 22. The layer 20 has a first surface 24, which faces inward relative to the house 12, and a second surface 26, which faces outward relative to the house 12. The adhesive layer 22 is applied to the first surface 24 and forms the means for attaching the housewrap sheet 10 to the sheathing 14.

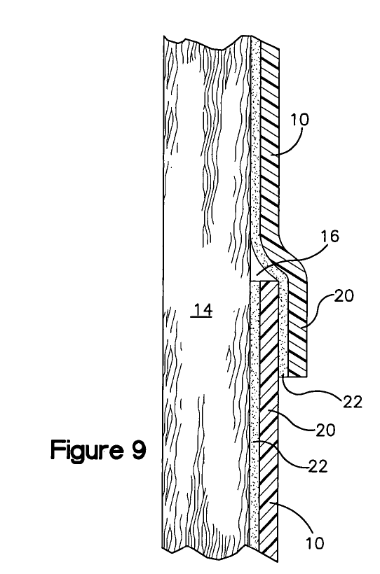

As shown in FIG. 6, the pre-installation housewrap 10 can include a release liner 30. Alternatively, as shown in FIG. 7, a release coating 32 can be applied to the outward surface 26 of the barrier layer 20 to prevent adhesion of the adhesive layer 22 on top thereof. The latter alternative may be more user-friendly, especially when the housewrap is provided in roll form. However, as is discussed below in connection with FIG. 9, the release liner 30 may be more preferable if the housewrap 10 also is intended to provide integral joint-sealing means.

The release liner 30 and/or the release coating 32 can be any of those known in the art such as, for example, sprayed silicone release coating. With particular reference to the coating 32, an added benefit of silicone is that it may help to prevent bulk water from entering the barrier layer 20, thereby enhancing its water/air barrier qualities. That being said, the release liner 30 and/or the release coating 32 (silicone or otherwise) should be selected so that it does not compromise the moisture vapor transmission rate of the barrier layer 20 and/or the adhesive layer 22.

The barrier layer 20 provides a moisture barrier against outside water or moisture, yet allows a high water vapor transmission (i.e., at least 100 g/m²/day, at least about 200 g/m²/day, at least about 300 g/m²/day, and/or about 400 g/m²/day) from the interior of the housing. Examples of materials suitable for layer 20 include polyolefins, such as polyethylene or polypropylene. The polymer material can be woven, cross-woven, non-woven, or spun-bonded, but is preferably non-perforated (e.g., does not have any mechanically formed perforations, microperforations or minute passageways such as may be found in the “Rufco-Wrap,” “Amowrap,” and “Air-Gard” housewraps discussed above.) Common and suitable housewrap materials include TYVEK, a high density polyethylene spun-bonded sheet material from Dupont Company, Wilmington, Del., and/or TYPAR house wrap, spun-bonded polypropylene fiber mat material from Reemay, Inc., Old Hickory, Tenn.

The adhesive layer 22 comprises a pressure sensitive adhesive and, more particularly, a pressure sensitive adhesive that has a high moisture vapor transmission rate (i.e., a high MVTR) that is a rate of at least about 100 g/m²/day, at least about 200 g/m²/day, at least about 300 g/m²/day, and/or about 400 g/m²/day. In this manner, the adhesive does not interfere or block the vapor transmission qualities of the layer 20, whereby water vapor which enters the walls from the interior of the building structure can exit so that it does not condense within the wall and potentially damage insulation and structural members. The water vapor transmission rate can be determined by ASTM Test Method E-96 and/or a MOCON testing system (developed by Modern Controls, Inc.) or its equivalent can be used. The high MVTR pressure sensitive adhesive is preferably a non-rubber-based adhesive and/or an acrylic-based adhesive.

A suitable high MVTR adhesive may be derived from the family of synthetic hydrophilic polymers, which includes polyacrylic acid, polyvinyl pyrrolidone, polyvinyl alcohol, polyacrylamide, poly hydroxybutyl acrylate, and poly 2-hydroxyethyl methacrylate. A method for making such a suitable pressure sensitive adhesive for the layer 22 is disclosed in U.S. Patent Application Publication No. 2001/0037006 A1. (The invention described in this publication is assigned to the assignee of the present invention, and its entire disclosure is hereby incorporated by reference.) In this method, a gel-free, hydrophilic copolymer of 2-hydroxyethyl methacrylate and 4-hydroxybutyl acrylate is prepared substantially in the absence of a chain transfer agent. The copolymer of 2-hydroxyethyl methacrylate and 4-hydroxybutyl acrylate is water-insoluble, water-absorbing, amphilic, elastic, abrasion resistant and has improved mechanical properties. More particularly, this pressure sensitive adhesive is a gel-free poly 2-hydroxyethyl methacrylate containing alkylene glycol methacrylate impurities in the range of about 3%, based on the weight of the monomer. Preferably, the alkylene glycol impurities are selected from the group consisting of ethylene glycol dimethacrylate, diethylene glycol monomethacrylate, methacrylic acid, and mixtures thereof in a total amount of no more than about 3% by weight of the monomer. The 2-hydroxyethyl methacrylate and 4-hydroxybutyl acrylate are introduced into a solution of alcohol and water and copolymerized to form a polymerization mixture. A polyalkylene glycol is then added to the polymerization mixture to form a hydrophilic pressure sensitive adhesive upon removal of said alcohol and water.

Another suitable high MTVR candidate for the adhesive layer 22 is the pressure sensitive adhesive disclosed in International Publication No. WO 01/42384 A2. (The invention described in this publication also is assigned to the assignee of the present invention, and its entire disclosure also is hereby incorporated by reference.) This water vapor-permeable pressure sensitive adhesive comprises a copolymer formed from a plurality of monomers. The plurality of monomers can comprise about 5 to 75% butyl acrylate and/or ethyl acrylate, about 5 to 45% 2-ethylhexyl acrylate and/or isooctyl acrylate, about 20 to 50% hydroxyethyl acrylate, 0 to about 10% of a N-vinyl lactam, and no carboxylic acid monomers. Alternatively, the plurality of monomers can comprise about 5 to 75% butyl acrylate and/or ethyl acrylate, about 5 to 45% 2-ethylhexyl acrylate and/or isooctyl acrylate, about 20 to 44% hydroxyethyl acrylate, 0 to about 10% of a N-vinyl lactam, and a positive amount up to about 6% acrylic acid and/or methacrylic acid.

Another high MTVR pressure sensitive adhesive is disclosed in U.S. Pat. No. 5,147,698, and the entire disclosure of this patent is hereby incorporated by reference. This adhesive is derived from the polymerization of a hydrophilic premix comprising at least one ethylenically unsaturated monomer. The adhesive film has dispersed therein a discontinuous gaseous phase constituting at least 10 percent of the volume of the film.

Another suitable pressure sensitive adhesive may be an acrylic emulsion adhesive, such as is supplied by Rohm & Haas as Acrylic Emulsion E-3173.

Other high MVTR adhesives are disclosed in U.S. Reissue Pat. No. 33,353. These adhesives include those described in U.S. Pat. No. Re. 24,906, particularly a copolymer of 96% iso-octyl acrylate units and 4% acrylamide units and a copolymer of 94% iso-octyl acrylate units and 6% acrylic acid units; those adhesives described in U.S. Pat. No. 3,389,827, which comprise block copolymers having three or more polymer block structures having a general configuration --A--B--A--, wherein each A is a thermoplastic polymer block with a glass transition temperature above room temperature (i.e., above about 20.degree. C.) having an average molecular weight between about 5000 and 125,000, and wherein B is a polymer block of a conjugated diene having an average molecular weight between about 15,000 and 250,000; and iso-octyl acrylate/n-vinyl pyrrolidone copolymer adhesives and crosslinked acrylate adhesives such as, for example, those described in U.S. Pat. No. 4,112,213. The entire disclosures of each of the patents cited in this paragraph is hereby incorporated by reference.

The selected adhesive balances the adhesion requirements and the vapor-transmission requirements, which are required to accommodate housewrap applications. While it may be possible to use different adhesives on different portions of the surface 26, the use of only one type of adhesive is preferred. The utilization of one adhesive (as opposed to two different types of adhesive) simplifies manufacturing procedures, which translates into reduced costs and decreased equipment complications.

It is further noted that the housewrap 10 of the present invention satisfies some different demands than do the strips or tapes that have traditionally been used to seal the joints between housewrap sections and/or the seams around window frames. (See e.g., U.S. Pat. Nos. 4,421,807; 5,374,477; 5,593,771; and 5,881,521 for further discussion and description of such strips/tapes.) Specifically, the substantially greater width of a housewrap sheet 10 makes central (i.e., not just along the edges) attachment necessary. That being said, certain aspects of the present invention can be incorporated into such sealing strips, and the present invention contemplates such incorporation.

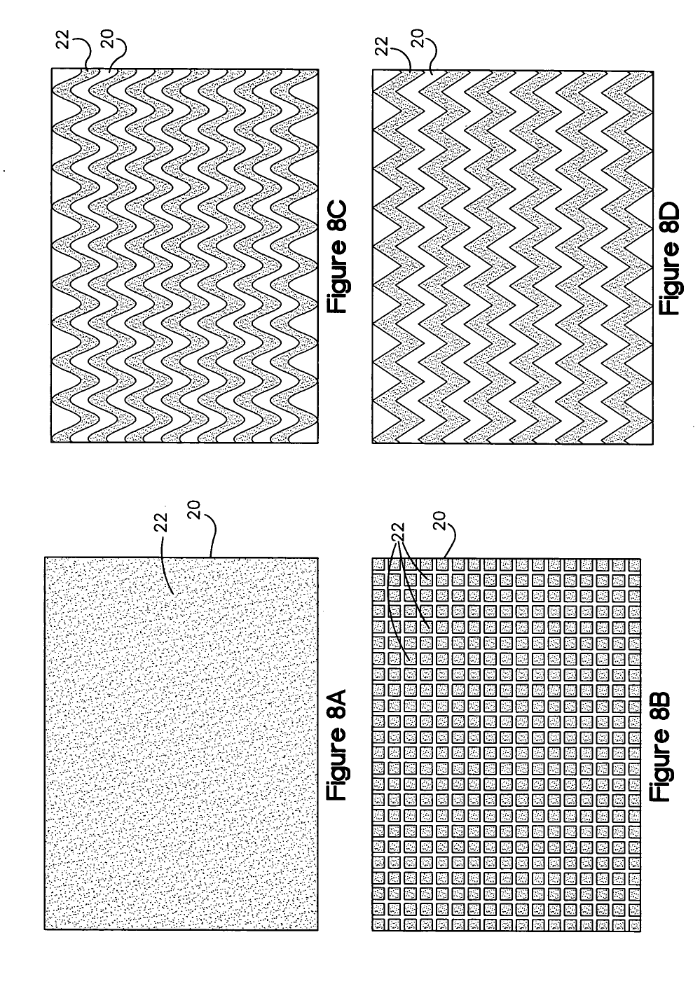

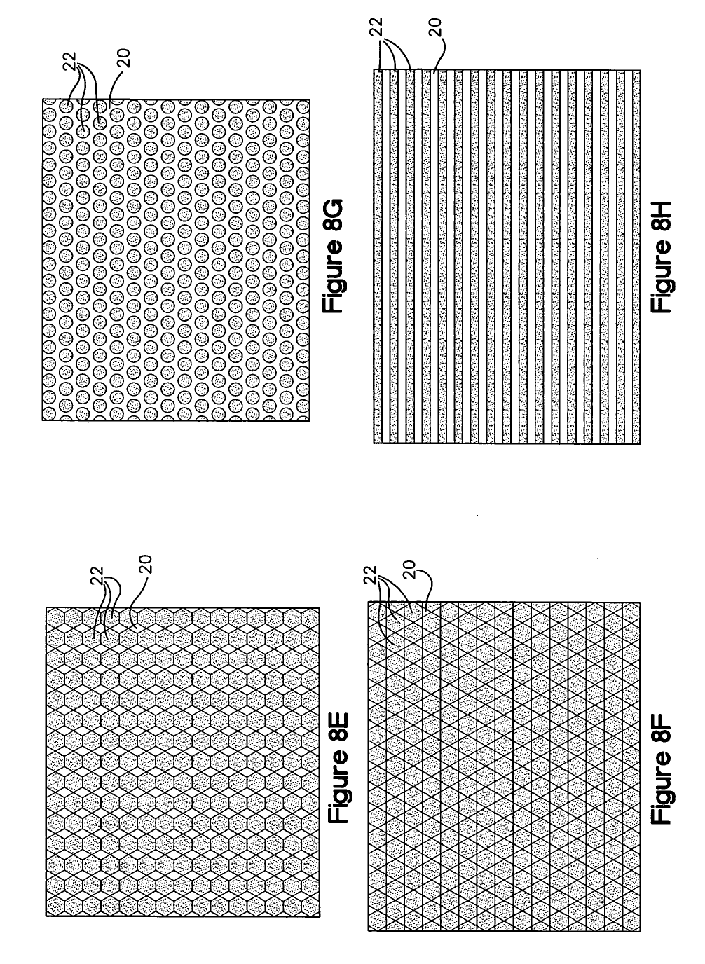

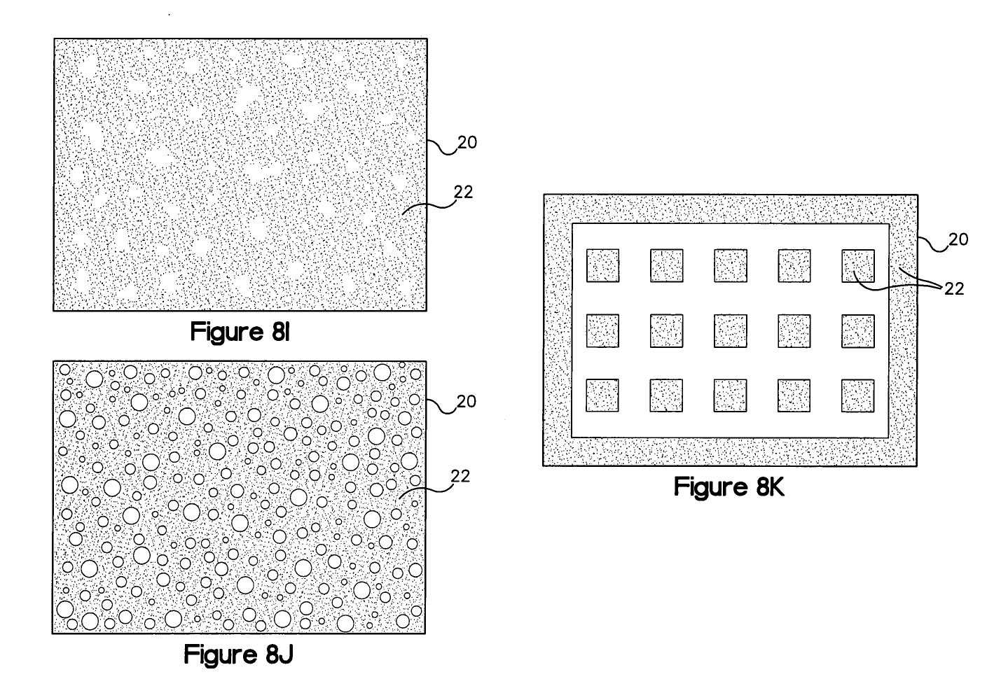

As shown in FIG. 8A, the adhesive layer 22 can substantially cover the surface 26. Alternatively, as shown in FIGS. 8B-8K, the adhesive layer 22 can be patterned over the barrier layer 20. For example, in FIG. 8B, the pattern comprises a patchwork pattern of unconnected squares. In FIG. 8C, the pattern comprises a longitudinally-extending sine design having smooth rounded waves, and in FIG. 8D the pattern comprises a longitudinally extending sine design having sharp triangular waves (e.g., zig-zag). In FIG. 8E, the pattern comprises a honeycomb design having cells positioned in aligned rows, and in FIG. 8F the pattern comprises a honeycomb design having cells positioned in offset rows. (While the illustrated honeycomb cells have a hexagonal shape providing hexagonal adhesive-free areas, these cells/areas can instead be circular, square, or other geometrical shapes.)

The pattern can be as simple as a series of dots, as shown in FIG. 8G, and/or a series of longitudinally extending stripes, as shown in FIG. 8H. The pattern can have a random positioning of voids, as shown in FIGS. 8I and 8J. Also, with particular reference to a case in which the housewrap 10 is provided in rectangular sections (FIGS. 2 and 4), the pattern can comprise a substantially solid perimeter border with a patchwork of squares positioned therein, as is shown in FIG. 8K.

Accordingly, the pattern of the adhesive layer can comprise a continuous or discontinuous network of geometric shapes. Suitable techniques for application of the adhesive include die coating, extrusion coating, gravure coating, spray coating, melt blowing, gravure printing, lithographic printing, flexographic printing (such as offset flexographic printing), or screen printing. The die coating or blowing techniques might be most effective with the solid design (FIG. 8A), the dot design (FIG. 8G), and/or the random-void designs (FIGS. 8I and 8J); while the printing techniques might be most effective with the patchwork, sine wave, honeycomb, dot, stripe, and border designs (FIGS. 8B-8G and FIG. 8J). In this regard, it is noted that the printing techniques allow for a concentration of adhesive in certain areas (e.g., the border in FIG. 8J) which may not be possible with some coating or blowing techniques.

With particular reference to the random-void designs shown in FIGS. 8I and 8J, it may be noted that such randomness may be accomplished in a variety of ways. By way of example, mechanical “chatter” can be introduced into the die gap (i.e., the gap between the die head and the back-up roll) so that its angle of approach will randomly change, thereby varying the distribution of adhesive on the barrier layer 22. (See FIG. 8I.) By way of another example, air (or another appropriate gas) can be ejected into the adhesive so that it is applied with a foam-like consistency. When the “air bubbles” in the applied adhesive foam burst on the barrier layer 20, a random distribution of circular voids will be created. (See FIG. 8J.) It can be noted that these random-void designs may have, in addition to adhesive-free areas, adhesive areas of varying densities/thicknesses. However, quite significantly, these areas need not be strategically located relative to certain regions (i.e., edge v. central regions) of the barrier layer 20. This allows manufacturing techniques to be less complicated and/or more efficient.

When the adhesive layer 22 has a non-solid pattern, as shown in FIGS. 8B-8J, the surface 26 will include areas free of adhesive. When the network is discontinuous (FIGS. 8B, 8G, and 8K), these areas are connected and, when the network is continuous (FIGS. 8C-8F and 8H-8J), these areas are disconnected. In either event, the adhesive-free area is determined by actual measurement of the areas of the surface 26 that are free of adhesive; that is, the areas whereat the surface is exposed because it is free of adhesive. The adhesive-free area is determined by using an Olympus SZH zoom stereo telescope and Image-Pro Plus software. A Pulnix video camera and television monitor are used to capture the image, and the software is used to measure the part of the surface 26 without adhesive. The area of the surface 26 that is adhesive-free is divided by the total area of the surface 26 and multiplied by one hundred to yield the adhesive-free area.

With the substantially full-coverage adhesion layer 22 shown in FIG. 8A, the adhesive-free area can be in the range of about 0% to about 5%. In the patterned adhesive layers 22 shown FIGS. 8B-8J, the adhesive-free area can be in a range of about 5% to about 25%, in a range greater than about 20% and less than about 60%, in a range greater than about 25%, and/or a range between about 5% and less than about 60%. That being said, a perhaps more significant aspect of the present invention is that, except in a border-like design such as that shown in FIG. 8J, the adhesive is uniformly distributed across the area of surface 26 without the need for strategic positioning of different types/densities of adhesive on respective regions (e.g., edge regions v. central regions). In other words, there is no intentional concentration of adhesive across the edges and no intentional void or reduced density in edge-interior regions.

Another significant aspect of the present invention is that the non-adhesive regions are not aligned or otherwise positioned relative to perforations or other openings in the barrier layer 20. The creation and/or alignment of perforations is not necessary with the present invention because the adhesive itself has a high water vapor transmission rate. (As was indicated above, the barrier layer 20 is preferably not perforated.) The elimination of perforation creation and/or perforation alignment results in the simplification of manufacturing procedures, which translates into reduced costs and increased efficiency.

It may be noted that whatever pattern the adhesive layer 22 may have, the pattern extends to the edges of the sheet 10. In this manner, adjacent edges of neighboring sheets 10 can overlap to seal the joint 16 therebetween, as is shown in FIG. 9. Specifically, the adhesive layer 22 of a first section is attached to the sheathing 14, and the adhesive layer 22 of a neighboring section is attached to barrier layer 20 of the first section. This eliminates the need for the use of tape or other strips to seal the horizontal and/or vertical joints 16 between sections of the housewrap 10.

If the housewrap 10 is intended to have the joint-sealing feature shown in FIG. 9 and discussed in the preceding paragraph, a release liner (such as release liner 30 shown in FIG. 6) may be preferable over a release coating (such as the release coating 32 shown in FIG. 7). Specifically, since the function of the release coating 32 is to prevent adhesion of the adhesive layer 22 on top thereof, this could interfere with joint-sealing. In such a case, tape or other sealing strips might be used to seal the horizontal and/or vertical joints 16 between sections of the housewrap 10.

The present invention further proposes adding a fungicide to the adhesive layer 22 to combat the creation of mold (e.g., Black mold (Stachybotris)) between the sheathing 14 and the barrier layer 20. The fungicide can be incorporated into the pressure sensitive adhesive prior to its application to the barrier layer or could be sprayed or otherwise applied thereafter. In either event, the selected fungicide and the selected pressure sensitive adhesive should be compatible; that is, the fungicide should not negatively affect the desired adhesive qualities unduly and the adhesive should not reduce the anti-bacterial qualities of the fungicide to an unreasonable extent. Also, the fungicide should not compromise the moisture vapor transmission rate of the adhesive layer 22 unduly and, preferably, the fungicide-incorporated adhesive layer still should have a moisture vapor transmission rate of at least 100 g/m²/day. Suitable fungicide candidates include pyrithiones, also known as 2-mercaptopyridine-N-oxide, 1-hydroxypyridine-2-thione, and 2-pyridinethiol-1-oxide. A zinc derivative (a chelated complex) known as zinc pyrithione, available as Zinc Omadine from Olin Corporation, Waterbury, Conn., provides good results. The IUPAC formula for the zinc derivative is bis[1-hydroxy-2(1H)-pyridinethionato-O,S]-(T-4) zinc.

One may now appreciate the present invention provides a housewrap, wherein nails/staples are not necessary, and wherein joint-sealing can be accomplished without the need for tape or other sealing means. Also, the housewrap of the present invention accommodates water vapor transmission rates without requiring overly complicated manufacturing techniques. Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

1. Housewrap for attachment to a building after installation of sheathing and prior to installation of siding/cladding, the housewrap comprising:
a barrier layer having a first surface, which faces inward relative to the building, and a second surface, which faces outward relative to the building; and
an adhesive layer applied to the first surface for attachment of the housewrap to the sheathing, wherein:
the barrier layer provides a moisture barrier against outside water or moisture, yet allows a water vapor transmission rate of at least 100 g/m²/day from the interior of the building;
the adhesive layer comprises a pressure sensitive adhesive that has a high moisture vapor transmission rate of at least about 100 g/m²/day; and
the adhesive layer substantially completely covers the first surface of the barrier layer.

2. The housewrap set forth in claim 2, wherein the barrier layer has a width of at least 2 feet.

3. Housewrap for attachment to a building after installation of sheathing and prior to installation of siding/cladding, the housewrap comprising:
a barrier layer having a first surface, which faces inward relative to the building, and a second surface, which faces outward relative to the building; and
an adhesive layer applied to the first surface for attachment of the housewrap to the sheathing, wherein:
the barrier layer provides a moisture barrier against outside water or moisture, yet allows a water vapor transmission rate of at least 100 g/m²/day from the interior of the building;
the adhesive layer comprises a pressure sensitive adhesive that has a high moisture vapor transmission rate of at least about 100 g/m²/day; and
the barrier layer has a width of at least 2 feet.

4. The housewrap set forth in claim 3, wherein the barrier layer has a width of at least 2 feet.

5. Housewrap for attachment to a building after installation of sheathing and prior to installation of siding/cladding, the housewrap comprising:
a barrier layer having a first surface, which faces inward relative to the building, and a second surface, which faces outward relative to the building; and
an adhesive layer applied to the first surface for attachment of the housewrap to the sheathing, wherein:
the barrier layer provides a moisture barrier against outside water or moisture, yet allows a water vapor transmission rate of at least 100 g/m²/day from the interior of the building;
the adhesive layer comprises a pressure sensitive adhesive that has a high moisture vapor transmission rate of at least about 100 g/m²/day; and
said pressure sensitive adhesive extends to the perimeter of the first surface.

6. The housewrap set forth in claim 5, wherein the barrier layer has a width of at least 2 feet.

7. Housewrap for attachment to a building after installation of sheathing and prior to installation of siding/cladding, the housewrap comprising:
a barrier layer having a first surface, which faces inward relative to the building, and a second surface, which faces outward relative to the building; and
an adhesive layer applied to the first surface for attachment of the housewrap to the sheathing, wherein:
the barrier layer provides a moisture barrier against outside water or moisture, yet allows a water vapor transmission rate of at least 100 g/m²/day from the interior of the building;
the adhesive layer comprises a pressure sensitive adhesive that has a high moisture vapor transmission rate of at least about 100 g/m²/day; and
the adhesive layer is applied in a pattern unrelated to perforations in the barrier layer.

8. The housewrap set forth in claim 7, wherein said pressure sensitive adhesive extends to the perimeter of the first surface.

9. The housewrap set forth in claim 7, wherein the barrier layer has a width of at least 2 feet.

10. The housewrap set forth in claim 7, wherein the barrier layer is non-perforated.

11. Housewrap for attachment to a building after installation of sheathing and prior to installation of siding/cladding, the housewrap comprising:
a barrier layer having a first surface, which faces inward relative to the building, and a second surface, which faces outward relative to the building; and
an adhesive layer applied to the first surface for attachment of the housewrap to the sheathing, wherein:
the barrier layer provides a moisture barrier against outside water or moisture, yet allows a water vapor transmission rate of at least 100 g/m²/day from the interior of the building;
the adhesive layer comprises a pressure sensitive adhesive that has a high moisture vapor transmission rate of at least about 100 g/m²/day; and
the barrier layer is non-perforated.

12. The housewrap set forth in claim 11, wherein said pressure sensitive adhesive extends to the perimeter of the first surface.

13. The housewrap set forth in claim 11, wherein the barrier layer has a width of at least 2 feet.

14. The housewrap set forth in claim 11, wherein the pressure sensitive adhesive has a water vapor transmission rate of at least about 200 g/m²/day.

15. The housewrap set forth in claim 14, wherein the pressure sensitive adhesive has a water vapor transmission rate of at least about 300 g/m²/day.

16. The housewrap set forth in claim 15, wherein the pressure sensitive adhesive has a water vapor transmission rate of about 400 g/m²/day.

17. The housewrap set forth in claim 11, wherein the barrier layer allows a water vapor transmission rate of at least about 200 g/m²/day.

18. The housewrap set forth in claim 17, wherein the barrier layer allows a water vapor transmission rate of at least about 300 g/m²/day.

19. The housewrap set forth in claim 18, wherein the barrier layer allows a water vapor transmission rate of at least about 400 g/m²/day.

20. The housewrap set forth in claim 11, wherein the barrier layer is a polyolefin material.

21. The housewrap set forth in claim 11, wherein the barrier layer is a spun-bonded material.

22. The housewrap set forth in claim 11, wherein a fungicide is added to the adhesive layer.

23. The housewrap set forth in claim 22, wherein the fungicide is a pyrithione.

24. The housewrap set forth in claim 23, wherein the fungicide is zinc pyrithione.

25. The housewrap set forth in claim 11, wherein the pressure sensitive adhesive is a non-rubber-based adhesive.

26. The housewrap set forth in claim 11, wherein the pressure sensitive adhesive is an acrylate-based adhesive.

27. The housewrap set forth in claim 11, wherein the pressure sensitive adhesive layer comprises a gel-free copolymer of 2-hydroxyethyl methacrylate and 4-hydroxybutyl acrylate.

28. The housewrap set forth in claim 27, wherein the 2-hydroxyethyl methacrylate contains impurities in a total amount of no more than about 3% by weight of the monomer, and wherein the impurities are selected from the group consisting of ethylene glycol dimethacrylate, diethylene glycol monomethacrylate, methacylic acid, and mixtures thereof.

29. The housewrap set forth in claim 11, wherein the pressure sensitive adhesive comprises an acrylate copolymer.

30. The housewrap set forth in claim 29, wherein the copolymer comprises about 5 to 75% butyl acrylate and/or ethyl acrylate, about 5 to 45% 2-ethylhexyl acrylate and/or isooctyl acrylate, about 20 to 50% hydroxyethyl acrylate, 0 to about 10% of a N-vinyl lactam, and no carboxylic acid monomers; or
the copolymer comprises about 5 to 75% butyl acrylate and/or ethyl acrylate, about 5 to 45% 2-ethylhexyl acrylate and/or isooctyl acrylate, about 20 to 44% hydroxyethyl acrylate, 0 to about 10% of a N-vinyl lactam, and a positive amount up to about 6% acrylic acid and/or methacrylic acid.

31. The housewrap set forth in claim 11, wherein the pressure sensitive adhesive is derived from the polymerization of a hydrophilic premix comprising at least one ethylenically unsaturated monomer, said film having dispersed therein a discontinuous gaseous phase constituting at least 10 percent of the volume of said film.

32. The housewrap set forth in claim 11, wherein the pressure sensitive adhesive comprises a copolymer of 96% iso-octyl acrylate units and 4% acrylamide units, and a copolymer of 94% iso-octyl acrylate units and 6% acrylic acid units.

33. The housewrap set forth in claim 11, wherein the pressure sensitive adhesive comprises block copolymers having three or more polymer block structures having a general configuration --A--B--A--.

34. The housewrap set forth in claim 33, wherein each A is a thermoplastic polymer block with a glass transition temperature above room temperature having an average molecular weight between about 5000 and 125,000, and wherein B is a polymer block of a conjugated diene having an average molecular weight between about 15,000 and 250,000.

35. The housewrap set forth in claim 11, wherein the pressure sensitive adhesive is an iso-octyl acrylate/n-vinyl pyrrolidone copolymer adhesive and/or crosslinked acrylate adhesive.

36. The housewrap set forth in claim 11, wherein the pressure sensitive adhesive is an acrylic emulsion adhesive.

37. The housewrap set forth in claim 11, further comprising a release liner positioned adjacent to the adhesive layer.

38. The housewrap set forth in claim 11, further comprising a release coating applied to the second surface of the barrier layer.

39. The housewrap set forth in claim 11, wherein the housewrap is provided on a roll and has an unrolled length of at least ten times its width.

40. The housewrap set forth in claim 11, wherein the housewrap is provided in sheets having a length within 20% of the width, about the same as the width, or longer than the width.

41. The housewrap as set forth in claim 40, wherein the sheets have a substantially rectangular shape.

42. The housewrap set forth in claim 11, wherein the adhesive layer substantially completely covers the first surface of the barrier layer.

43. The housewrap set forth in claim 11, wherein the adhesive layer is applied in a pattern which does not substantially completely cover the first surface of the barrier layer.

44. The housewrap set forth in claim 43, wherein the pattern essentially consists of a random arrangement of adhesive and/or a random arrangement of adhesive voids.

45. The housewrap set forth in claim 44, wherein the random pattern is mechanically introduced into the adhesive when applying the adhesive to the barrier layer.

46. The housewrap set forth in claim 45, wherein chatter is introduced into a die head applying the adhesive to vary its angle of approach and thus the distribution of adhesive.

47. The housewrap set forth in claim 44, wherein the random pattern is formed by injecting a gas into the adhesive.

48. The housewrap as set forth in claim 47, wherein the applied adhesive has a foam-like consistency and, upon bursting of the bubbles in this foam, circular adhesive-free voids are formed.

49. The housewrap set forth in claim 43, wherein the adhesive layer has an adhesive-free area in a range of about 5% to about 25%.

50. The housewrap set forth in claim 43, wherein the adhesive layer has an adhesive-free area in a range greater than about 20% and less than about 60%.

51. The housewrap set forth in claim 43, wherein the adhesive layer has an adhesive-free area in a range greater than about 25%.

52. In combination, a building and sections of the housewrap of claim 11 attached to the building after installation of sheathing and prior to installation of siding/cladding.

53. The combination set forth in claim 52, wherein adjacent edges of neighboring housewrap sections overlap to seal the joint therebetween; the adhesive layer of the first section being attached to the sheathing, and the adhesive layer of the second section being attached to barrier layer of the first section.

54. The combination set forth in claim 52, wherein tapes or sealing strips are used to seal the joints between adjacent edges of neighboring housewrap sections.

55. A method of housewrapping a building, said method being performed after installation of sheathing and prior to installation of siding/cladding and comprising the steps of:
positioning the housewrap of any of the preceding claims relative to the building so that the first surface of the housewrap layer faces inward, and the second surface of the housewrap layer faces outward; and
attaching the housewrap to the building by applying pressure to the second surface of the housewrap material layer so that the adhesive layer attaches the housewrap to the sheathing.

56. A method as set forth in claim 55, further comprising the step of removing a release liner from the adhesive layer prior to said positioning and attachment steps.

57. A method as set forth in claim 55, further comprising the step of overlapping adjacent edges of neighboring housewrap sections to seal the joint therebetween.

58. A method as set forth in claim 55, wherein strips or tape are used to seal the joints between adjacent edges of neighboring housewrap sections.
